(19) United States
(12) Patent Application Publication
(10) Pub. No.: US 2009/0028369 A1
(43) Pub. Date: Jan. 29, 2009

(54) INFLATABLE SPEAKER ROLL

(76) Inventors: Jack K. Reinhardt, Newaygo, MI (US); John K. Pasley, San Diego, CA (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/781,478

(22) Filed: Jul. 23, 2007

(51) Int. Cl. H04R 1/20

(52) U.S. Cl. 381/345

(57) ABSTRACT

A speaker assembly includes a cone structure having an outside opening and an inside opening adjacent a sound producing driver, wherein the outside opening is larger than the inside opening. A surround is connected to the outside opening of the cone and is defined by a circular airtight bladder with an interior cavity having a predetermined interior pressure. A frame is proximate an outside diameter of the surround.

### BACKGROUND OF THE PRESENT INVENTION

The present invention relates to a speaker assembly and specifically to a speaker assembly that includes an inflatable surround.

In one example of a speaker assembly, a permanent magnet and associated metal top plate, back plate and pole piece create a constant magnetic field in a radial air gap. A cylindrical voice coil wound with electrically conductive wire, typically copper, aluminum or copper clad aluminum, is placed in the radial air gap. An AC electrical input signal is applied to the cylindrical voice coil which creates a corresponding time-varying current in the electrically conductive wire wound on the cylindrical voice coil. As a result, a force resulting from the repulsion or attraction between the cylindrical voice coil and the permanent magnet is generated. When the electrical input signal changes, so does the charge in the cylindrical voice coil. More specifically, as the input signal changes, the polar orientation of the cylindrical voice coil changes, which generates an axial motion of the voice coil relative to the permanent magnet that is analogous to the input signal. As the voice coil moves axially relative to the permanent magnet sound is created.

The axial motion or excursion of this moving assembly must be constrained to minimize over excursion in either positive or negative direction, as well as any other uncontrollable motion such as rocking or yaw that could cause undesired voice coil rubbing on the internal speaker assembly. In addition, the axial motion must be constrained to minimize jumping of the voice coil from the air gap which can cause significant signal distortion and failure of the speaker assembly.

Axial motion of the voice coil is generally constrained by inner and outer flexible annuli commonly referred to as the speakers' mechanical suspension system. The inner annulus, often referred to as a spider, is typically a resin-impregnated sheet of woven cloth, nomex, nomex Kevlar, or other similar woven material that is thermally formed into a disc shape having a series of circumferential pleats or corrugations designed to control linear axial excursion of the voice coil assembly over a specific range of motion beyond which the spider will progressively limit axial excursion.

The outer annulus, or surround, attaches the perimeter of the cone diaphragm to the frame. The surround is an important stabilizing element of the moving speaker assembly. The surround and the spider function as mechanical springs that have a relatively linear excursion region. Both the surround and spider are measured in terms of compliance and the inverse of compliance—stiffness. The surround and spider compliances are considered to operate mechanically in parallel because both have a proximal side at zero velocity (where attached to the frame of the speaker assembly) and both have a distal side at the velocity of the voice coil.

The combined stiffness of the surround and the spider acting as a spring on the effective moving mass of the voice coil and cone assembly determines the fundamental mechanical resonance frequency of the speaker. The fundamental mechanical resonance frequency is an important parameter of speaker design and impacts speaker performance, and particularly the low frequency limit of performance. The ability to control and modify the fundamental mechanical resonance frequency in a speaker assembly would be a useful design tool.

Accordingly, a way to control the fundamental mechanical resonance frequency by varying the compliance of the surround would be valuable.

### SUMMARY OF THE INVENTION

In one aspect of the present invention, a speaker assembly includes a cone structure having an outside opening and an inside opening adjacent a sound producing driver, wherein the outside opening is larger than the inside opening. A surround is connected to the outside opening of the cone and is defined by a circular airtight bladder with an interior cavity having a predetermined interior pressure. A frame is proximate to and rigidly secures the outside diameter of the surround.

In another aspect of the present invention, a surround for a speaker assembly includes a substantially airtight tubular bladder including an exterior side and an interior side. The interior side defines a cavity, wherein the airtight tubular bladder is connected to a speaker cone. An air valve is connected to the airtight tubular bladder and is adapted to allow the airtight tubular bladder to be pressurized or depressurized.

In another aspect of the present invention, a method of altering the sound emitted from a speaker assembly includes providing a motor structure having a frame and adapted to produce sound waves, providing a surround adjacent to the frame and that includes an airtight bladder defining an interior cavity, providing a cone having an inner diameter and an outer diameter, wherein the outer diameter is adjacent to the surround, and maintaining a gas inside the airtight bladder.

These and other features, advantages and objects of the present invention will be further understood and appreciated by those skilled in the art upon studying the following specification, claims, and appended drawings.

### BRIEF DESCRIPTION OF THE DRAWINGS

FIG. 1 is a perspective view of a speaker assembly embodying the present invention;

FIG. 2 is a perspective view of a speaker basket and a speaker cone;

FIG. 3 is a top elevational view of a speaker cone;

FIG. 4A is a bottom plan view of a speaker cone;

FIG. 4B is a top plan view of the speaker cone of FIG. 4A;

FIG. 5 is an enlarged cross-sectional view of the speaker cone of FIG. 3, taken along the line V-V;

FIG. 5A is a top plan view of another embodiment of the present invention;

FIG. 5B is an enlarged cross-sectional view of the speaker cone of FIG. 5A taken at line VB-VB;

FIG. 6 is an enlarged side elevational view of a speaker cone;

FIG. 7A is a top plan view of another embodiment of the present invention; and

FIG. 7B is an enlarged side cross-sectional view of the speaker cone of FIG. 7A taken at line VIIB-VIIB.

### DETAILED DESCRIPTION OF PREFERRED EMBODIMENTS

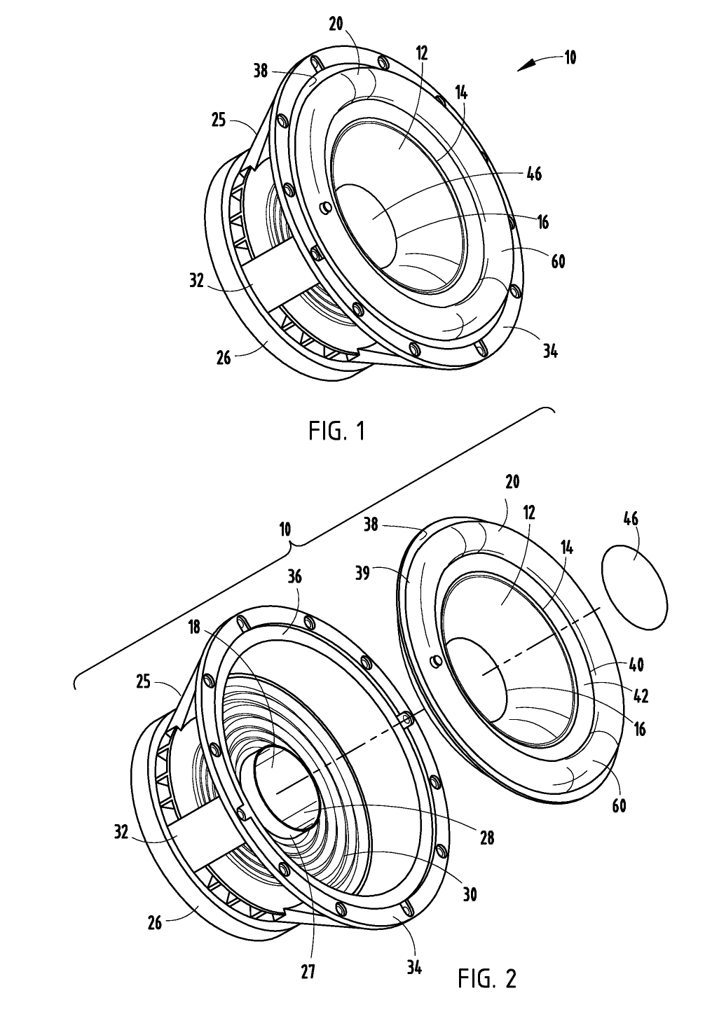

For purposes of description herein the terms “upper”, “lower”, “right”, “left”, “rear”, “front”, “vertical”, “horizontal” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

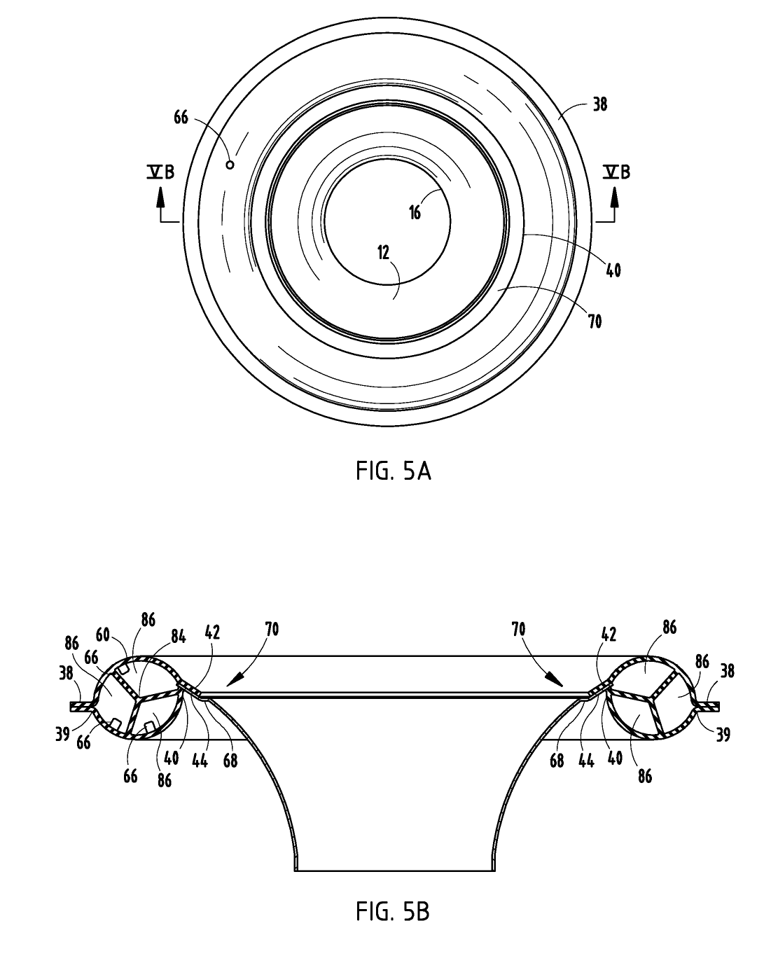

Speaker assembly 10, as shown in FIGS. 1 and 2, includes a cone structure 12 having an outside opening 14 and an inside opening 16 adjacent a sound producing driver 18, wherein the outside opening 14 is larger than the inside opening 16. A surround 20 is connected to the outside opening 14 of the cone 12 and is defined by a circular airtight bladder 22 with an interior cavity 24 (FIG. 5) having a predetermined interior pressure. A frame 25 is proximate an outside diameter of the surround 20.

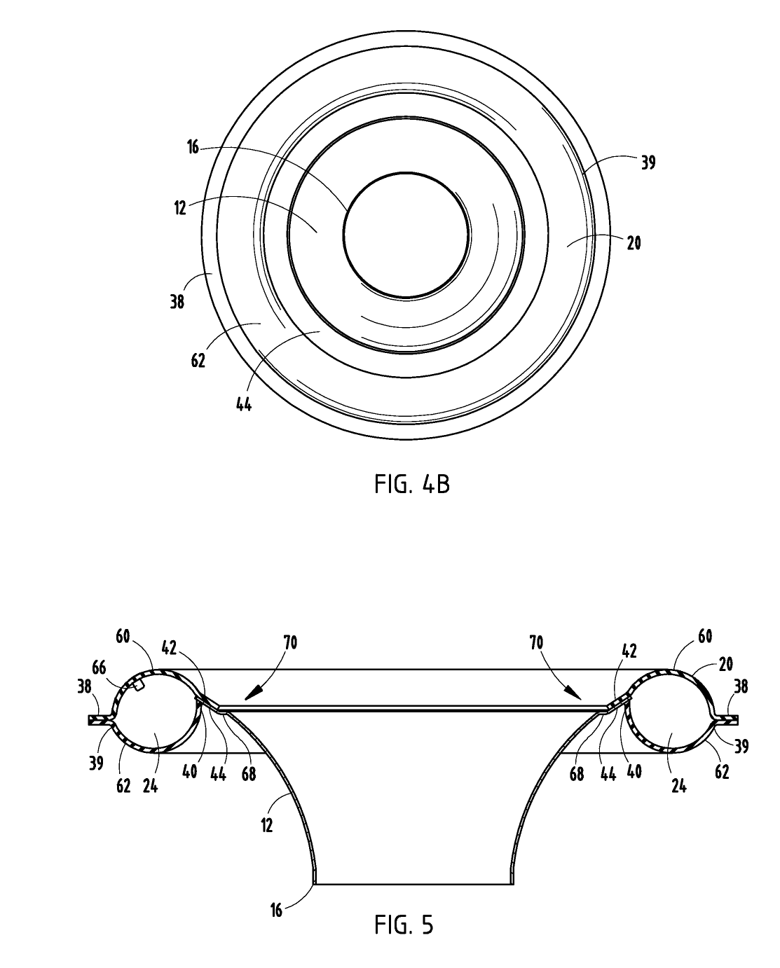

Referring now to FIG. 2, the driver 18 of the speaker assembly 10 is protected by a driver housing 26. The driver 18 projects sound from a sound projecting aperture 28 that is centrally located and surrounded by a spider 30. The spider 30 has a circumferentially pleated material that acts as a spring system inside the speaker assembly 10. The driver housing 26 includes a series of support members 32 that extend from the driver housing 26 and terminate at a rim 34. The rim 34 includes an inside circumferential ledge 36 adapted to receive an outside flange 38 located on the outer circumference 39 of the surround 20. An inner circumference 40 of the surround 20 includes an inside flange 42 that connects with an outer lip 44 (FIG. 4B) of the cone 12 as discussed further below. The inside opening 16 of the cone 12 is adjacent to a dust cover 46 that rests on or above a cylinder 27 that defines the sound projecting aperture 28 of the speaker assembly 10.

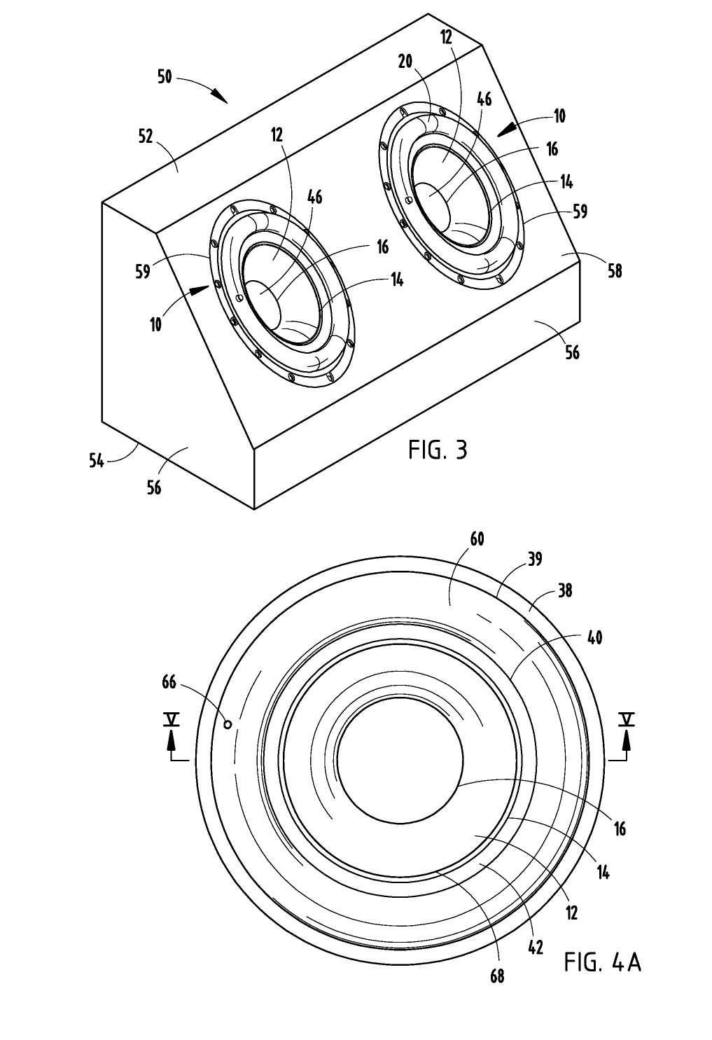

As shown in FIG. 3, a speaker box 50 includes top and bottom walls 52, 54 as well as side walls 56. In addition, a speaker wall 58 extends between and connects the top wall 52 and one of the side walls 56. The speaker wall 58 extends at an angle and includes at least one speaker aperture 59 designed to receive at least one speaker assembly 10. The speaker box 50 may be constructed from various materials including plastic, wood, aluminum or metal and is substantially rigid and airtight and has a generally hollow interior.

Referring now to FIGS. 4A and 4B, the surround 20 is substantially toroidally-shaped and includes a top half 60 and a bottom half 62 that form the airtight bladder 22 defining the interior cavity 24 (FIG. 5). The surround 20 may be constructed from a variety of materials including elastomers such as butyl rubber, natural rubber, polybutadiene, etc. The inside flange 42 extends inwardly from the inner circumference 40 of the surround 20 and is fixedly connected to the outer lip 44 of the cone 12. The inside flange 42 may be formed from the top half 60 of the surround 20 as shown, or the bottom half 62, or both the top half 60 and the bottom half 62. A gas valve 66 is located in the top half 60 and is adapted to allow various mediums such as ambient air, water, nitrogen, helium, noble gases, and argon to be forced into, or allowed out of the bladder 22 when the gas valve 66 is actuated. Specifically, the gas valve 66 may be actuated by a user to allow gas to escape the bladder 22 if under positive pressure and to enter the bladder 22 if under negative pressure. It is contemplated that virtually any medium in a liquid or gas state can be inserted into the bladder 22 of the surround 20. The use of various mediums alters the fundamental mechanical resonance of the speaker assembly 10 and therefore impacts the sound heard by a user. In applications where a larger speaker is needed, mass can be added by way of the bladder 22 to alter compliance. Smaller applications require less effective moving mass and so the bladder 22 could be filled with ambient air or helium, for example.

As shown in FIG. 5, the top and bottom halves 60, 62 of the bladder 22 of the surround 20 are hermetically sealed to form the outside flange 38. Alternatively, the outside flange 38 may be a separately added ring attached to the outside diameter of the surround 20. It is also contemplated that the outside flange 38 could be formed primarily from just one of the top half 60 or bottom half 62 of the surround 20. The speaker cone 12 and the outer lip 44 are separated by an offset ledge 68. As previously mentioned, the inside flange 42 of the top half 60 of the bladder 22 is fixedly attached to the outer lip 44 of the speaker cone 12. The offset ledge 68 sets the outer lip 44 of the cone 12 back a distance approximately equal to the thickness of the inside flange 42 of the surround 20. As a result, the transition area 70 from the cone 12 to the inside flange 42 of the surround 20 is relatively smooth and even.

Referring to FIGS. 5A and 5B, the bladder 22 of the surround 20 may include multiple airtight chambers 80 that store various mediums at various or uniform pressures. As shown in FIG. 5B, circumferential walls 84 inside the bladder 22 of the surround 20 may extend parallel with the circumferential extent of the top half 60 and bottom half 62 of the bladder 22 to form multiple chambers 86. It is contemplated that any combination of circumferential walls 84 may be utilized to alter the sound emitted by the speaker assembly 10. Cross-sectionally the bladder 22 (or bladders) may be round, or elliptical, or at varying form to create a desired acoustical effect. Furthermore, the bladder 22 (or bladders) may be compartmentalized radially so that specific chambers 80 may be inflated or deflated individually to achieve the desired acoustical effect.

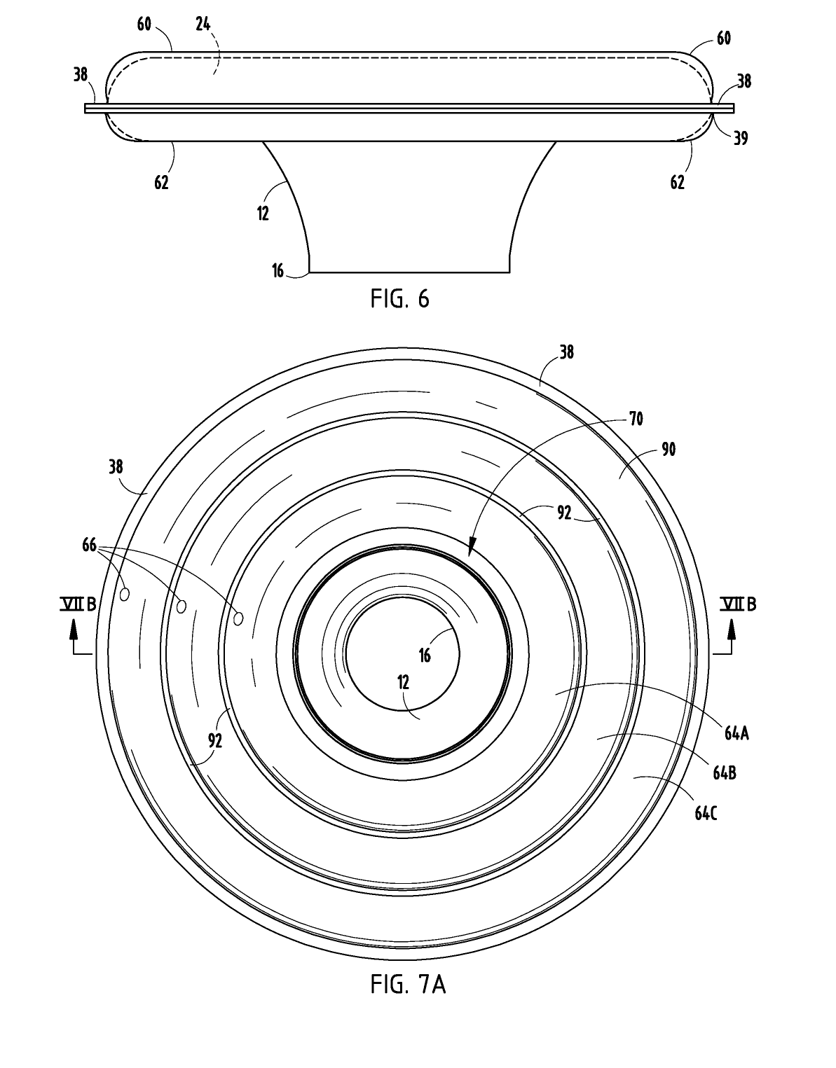

Referring now to the example shown in FIG. 6, the bladder 22 of the surround 20 can be inflated to include a pressure higher or lower than that of the surrounding atmosphere. It is contemplated that a highly stiff, yet somewhat pliable surround 20 could have an internal pressure less than or more than the surrounding atmosphere. It is also contemplated that a surround 20 having a high compliance could include an internal pressure greater than the surrounding atmosphere and that this form of surround 20 could in fact stretch to fit various size speaker apertures, thereby increasing the versatility of a single speaker assembly 10.

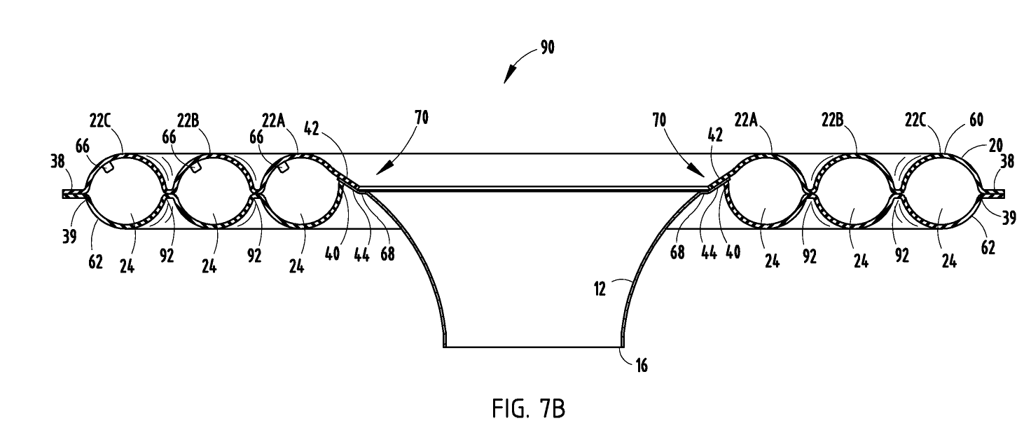

As shown in the example illustrated in FIGS. 7A and 7B, a multi-bladdered surround 90 for the speaker assembly 10 includes airtight bladders 22A, 22B, and 22C, which are aligned in increasing size concentrically around the cone 12. Any number of bladders is contemplated and the number may vary depending on the application for which the speaker assembly is to be used. The bladders 22A, 22B, and 22C are separated by a sealed join 92 that extends circumferentially around the cone 12 between bladder 22A and 22B, as well as between 22B and 22C. The bladders 22A, 22B, and 22C can be of any size, diameter, volume, etc. and such sizing constraints will vary depending on the intended use of the particular speaker assembly. The bladders 22A, 22B, and 22C can be filled with any of a number of gases or fluids, as disclosed above. Further, each bladder 22A, 22B, and 22C may be filled with different materials and/or at different pressures. For example, bladder 22A could be filled with air at the surrounding atmospheric pressure, bladder 22B could be filled with pressurized air, and bladder 22C could be filled with a noble gas such as helium. As a result of this exceptional versatility, a wide spectrum of effective moving mass values over the cross-section of the speaker assembly can be created, thereby providing a wide range of sound variance.

The above description is considered that of the preferred embodiments only. Modifications of the invention will occur to those skilled in the art and to those who make or use the invention. Therefore, it is understood that the embodiments shown in the drawings and described above is merely for illustrative purposes and not intended to limit the scope of the invention, which is defined by the following claims as interpreted according to the principles of patent law, including the Doctrine of Equivalents.

The invention claimed is:

1. A speaker assembly comprising:
a cone structure having an outside opening and an inside opening adjacent a sound producing driver, wherein the outside opening is larger than the inside opening;
a surround connected to the outside opening of the cone and defined by a circular airtight bladder with an interior cavity having a predetermined interior pressure; and
a frame proximate an outside diameter of the surround.

2. The speaker assembly of claim 1, further including:
a motor structure.

3. The speaker assembly of claim 2, wherein:
the bladder is filled with nitrogen.

4. The speaker assembly of claim 2, wherein:
the bladder is filled with helium.

5. The speaker assembly of claim 2, further including:
the speaker assembly includes a gas valve connected to the surround and adapted to allow the bladder to be pressurized or depressurized.

6. The speaker assembly of claim 5, further including:
a flange extending outwardly from the surround.

7. The speaker assembly of claim 1, wherein:
the speaker assembly includes a gas valve connected to the surround and adapted to allow the bladder to be pressurized or depressurized.

8. The speaker assembly of claim 7, wherein:
the volumetric space of an interior cavity defined by the airtight bladder is substantially larger when the airtight bladder is filled to a performance interior pressure.

9. The speaker assembly of claim 8, wherein:
the surround is constructed from a flexible, airtight elastomer.

10. The speaker assembly of claim 9, further including:
a motor structure.

11. A surround for a speaker assembly comprising:
a substantially airtight tubular bladder including an exterior side and an interior side, the interior side defining a cavity, wherein the airtight tubular bladder is connected to a speaker cone; and
an air valve connected to the airtight tubular bladder adapted to allow the airtight tubular bladder to be pressurized or depressurized.

12. The surround of claim 11, including:
a flange that is integral with an inside diameter of the surround and connected to the outside opening of the cone.

13. The surround of claim 12, wherein:
the bladder is filled with nitrogen.

14. The surround of claim 12, wherein:
the bladder is filled with helium.

15. The surround of claim 16, wherein:
the surround is constructed from a flexible, airtight elastomer.

17. A method of altering the sound emitted from a speaker assembly, comprising:
providing a motor structure having a frame and adapted to produce sound waves;
providing a surround adjacent to the frame and that includes an airtight bladder defining an interior cavity;
providing a cone having an inner diameter and an outer diameter, wherein the outer diameter is adjacent to the surround;
maintaining a gas inside the airtight bladder.

18. The method of claim 17, including:
a gas valve that connects the airtight bladder to the atmosphere that can be opened and closed.

19. The method of claim 18, wherein:
The surround is adjustable between an inflated position and a deflated position.

20. The method of claim 19, wherein:
the airtight bladder of the surround is filled with a noble gas.
